(19) United States
(12) Patent Application Publication
(10) Pub. No.: US 2008/0033652 A1
(43) Pub. Date: Feb. 7, 2008

(54) Determining and displaying the geographic location of articles

(76) Inventors: Patrick Hensley, Jersey City, NJ (US); Jonathan J. Harris, Brooklyn, NY (US)

Correspondence Address: ELLIOT FURMAN, 15 WEST 81ST STREET #11J, NEW YORK, NY, 10024, US

(21) Appl. No.: 11/833,442

(22) Filed: Aug. 3, 2007

Related U.S. Application Data
(60) Provisional application No. 60/821,566, filed on Aug. 5, 2006.

(51) Int. Cl. G06F 19/00

(52) U.S. Cl. 702/5

(57) ABSTRACT

A method determines and displays the geographic location of a plurality of articles. At least one geographic location of each of the plurality of articles is determined. The determining includes extracting entities of the article, determining which extracted entities are places entities, determining a geographic location of each of the places entities, and attributing the geographic location of each of the places entities with the article. A map is created. The map comprises a geographic map. A plurality of clickable markers are displayed on the map. The clickable markers correspond to the geographic locations of the plurality of articles. Attributes of the markers may be modified. When a marker is clicked on, a web page may be instantly published, the web page comprising articles having a geographic location of the marker that was clicked on.

This application claims the benefit of U.S. Provisional Application No. 60/821,566, filed Aug. 5, 2006, which is hereby incorporated by reference.

### BACKGROUND

Online news sites such as http://abcnews.go.com/, http://news.yahoo.com, http://news.google.com aggregate and display stories from all over the world. The main web page on these and like websites typically display stories according to general categories such as “World”, “Business”, “Technology”, “Science”, “Technology”, “Entertainment”, “Top Headlines”, “Money”, “Opinion”, “Politics”, “Travel”, “Sports”, “Most Popular”, and the like.

An Internet user reading a news site clicks on one of the general categories to view a web page with stories on that one general category. The web page displays the stories divided by more specific sub-categories. For example, a user selecting the general category “World” is brought to a page displaying stories which are separated into the following exemplary sub-categories: “Middle East”, “Europe”, “Latin America”, “Africa”, “U.S.”, “Asia”, and the like. In another example, a user selecting the general category “Business” is brought to a page displaying stories with are separated into the following exemplary sub-categories: “Economy”, “Stock Market”, “Personal Finance”, “Industries”, “Press Releases”, and the like.

A user may select any of these sub-categories to view stories in the sub-category. Typically, there are no sub-sub-categories. And, many times a general category will not even have a sub-category; only a list of available stories is displayed without any type of even the most rudimentary indexing.

It is therefore very difficult and cumbersome to find stories covering a particular subject or geographic area. For example, a user wishing to find stories that take place in or are related to Peru must click through more than one page to get to the “Latin America” page (that is, if the category is even available), and then browse through many articles, perhaps even dozens of article, to find the stories related to, written in, or written about Peru. If there are many stories in the “Latin America” sub-category, the reader may simply give up after browsing through many unrelated articles, and thus miss an important or interesting story.

Furthermore, short of a text search, there is no easy way for a user to find articles that may be related to “Latin America” but do not take place in Latin America or are primarily about Latin America. For example, a story about U.S. trade may talk about Venezuela but may be categorized as “U.S.” or as “Politics”. A user must read through many different stories in many different categories to find related stories like this.

Also, even if a user finds related stories, there is no way for the user to determine, in a single glance of web page, where related stories are taking place in the world. And there is no way for a user to easily display a list of related stories in other parts of the world with one click of the mouse.

Additionally, for stories that cover a topic that where the geographic location is not of primary importance, the geographic location may have a secondary importance. For example, a businessperson may in general be interested in company earnings announcements, but may specifically be interested in companies in Silicon Valley. In this example, in the prior art, business news such as company earnings for companies in Silicon Valley may be listed with all other such business news from all over the world, for example earnings from companies in Mumbai, India. There is currently no way for a user to intuitively see where earnings reports are taking place throughout the world, and to navigate to any desired region.

In another example, a user may wish to see opinions or editorials written in or published about the Midwest region of the United States. Or a user may be interested in where stories are being covered. Presently such editorials are mixed in with many other editorials. It would be advantageous if a user could see, along with a list of editorials, a map of where those editorials were published or the region they are about.

The best the prior art does in empowering user to find stories of specific interest is to provide a search function on the news site. Using this search function, a user may search for all stories having user specified terms or keywords. Some sites provide a means to personalize the user's news page by entering keywords and displaying a custom, constantly updated news page consisting of a sample of articles containing those keywords. However changing these custom keyword pages is cumbersome. The keyword pages dot not provide information into how stories are geographically related, and they not provide the ability to instantly navigate to different regions of the world based on these geographical relations.

Thus, a need presently exists for determining and displaying the geographic location of a story or entity in a story, and browsing stories.

### BRIEF DESCRIPTION OF DRAWINGS

FIG. 1 shows an exemplary news page including an exemplary map displaying locations of articles.

FIG. 2 shows an enlarged view of the exemplary map of FIG. 1.

FIG. 3 shows an enlarged view of the exemplary map after selecting a location displayed on the map.

FIG. 4 shows a news page created after selecting a location such as shown in FIG. 3 .

### SUMMARY

A method determines and displays the geographic location of a plurality of articles. At least one geographic location of each of the plurality of articles is determined. The determining includes extracting entities of the article, determining which extracted entities are places entities, determining a geographic location of each of the places entities, and attributing the geographic location of each of the places entities with the article. A map is created. The map comprises a geographic map. A plurality of clickable markers are displayed on the map. The clickable markers correspond to the geographic locations of the plurality of articles. Attributes of the markers may be modified. When a marker is clicked on, a web page may be instantly published, the web page comprising articles having a geographic location of the marker that was clicked on.

### DETAILED DESCRIPTION

The following patent applications are hereby incorporated by reference: U.S. application Ser. No. 11/260,720, filed Oct. 27, 2005, and entitled “Newsmaker verification and commenting method and system”; U.S. application Ser. No. 11/463,061, filed Aug. 08, 2006, and entitled “Method for creating a disambiguation database”; U.S. application Ser. No. 11/531,360, filed Sep. 13, 2006, and entitled “Ambiguous entity disambiguation method”.

Entity Extraction

Entity extraction, or named entity extraction, refers to information processing methods for extracting information such as names, places, and organizations from machine readable documents. One example of a machine readable document is an on-line article. For example, an on-line article may be a news story available on the Internet from Internet connected news server.

As is well known, articles are displayed in a web browser on a client computer simply by typing in the web address, referred to more broadly as a universal resource identifier (URI), of any of the news servers. News servers may serve news from thousands of online local, regional, national, and international news outlets supplying news from sources such as Agence France-Press (AFP), Reuters, Associated Press (AP), Los Angeles Times, New York Times, USA Today, National Public Radio (NPR), CNN.com, Slashdot.org. There are many other news servers where Internet users can receive news from, such as Yahoo! News (http://news.yahoo.com) and Google News (http://news.google.com). These and other similar websites sometimes do not generate any original news content, but they aggregate news from a multiplicity of news servers, thus providing a convenient way for Internet users to view articles from a multiplicity of sources from a single website.

An article may be a news article or any other type of article, whether or not it contains current news. The article may comprise aggregated content from a multiplicity of other articles. An article comprises text, with at least some of the text comprising entities. The article may further comprise an image or images, links to audio and video, embedded audio and video, links to other articles, links to web pages and blogs, and the like. As used herein, the term “web browser content” is understood to mean, either by themselves or in combination, text, an image or images, links to audio and video, embedded audio and video, links to other articles, links to web pages and blogs, and other types of content that are displayable or accessible in a web browser.

Entity extraction can be applied to an article to extract entities such as names of people, places, and organization. Dates, time, and numerical quantities such as monetary values may also be extracted. For example, entities in an article on a political subject may include people entities such as the U.S. President, senators, news commentators, and the like. It may also include organization entities such as the Pentagon, the White House, or a corporation such as Halliburton. It may also include places entities such as the United States, Iraq, and Baghdad.

Many well understood linguistic, knowledge-based, statistical, probabilistic, and hybrid methods for entity extraction may be employed, and currently are in prior art implementations. In one embodiment Hidden Markov Models are used. In other embodiments, rule-based methods, machine learning techniques such as Support Vector Machine learning methods, and Conditional Random Fields are implemented either by themselves or in combination.

There are many commercial products available employing these and other techniques, for example IdentiFinder™ from BBN Technologies, products from Basis Technology Corp., Verity Inc., Convera, and Inxight Software Inc.

Freely available software for developing and deploying software components that process human language include GATE (General Architecture for Text Engineering, http://gate.ac.uk), and OpenNLP (http://opennlp.sourceforge.net), which is a collection of open source projects related to natural language processing. These methods, models, algorithms, systems, and products are well understood by those of ordinary skill in the art and are routinely used to extract entities from on-line content such on-line articles, as well as content that is not available on-line such as private databases and files.

Geographic Location of a Story or Entity in a Story, and Browsing Stories

Appendix A entitled “Preparing the Geographic Database (“database”) discloses a method for preparing a geographic database. The geographic database is used to resolve the location of entities in an article, and by extension the article.

Appendix B entitled “Location Resolution Algorithm (“algorithm”) and Multiple Match Subroutine” discloses a method for determining the location of entities in an article through the database.

Articles, as described above, are stored (for example either locally or as a hyperlink) in an articles database along with location information. When rendering a news page, the location information as determined, for example, by the methods of Appendix A and B, can be used as headings on the page to provide a location index, and thus display articles on a news page according to location.

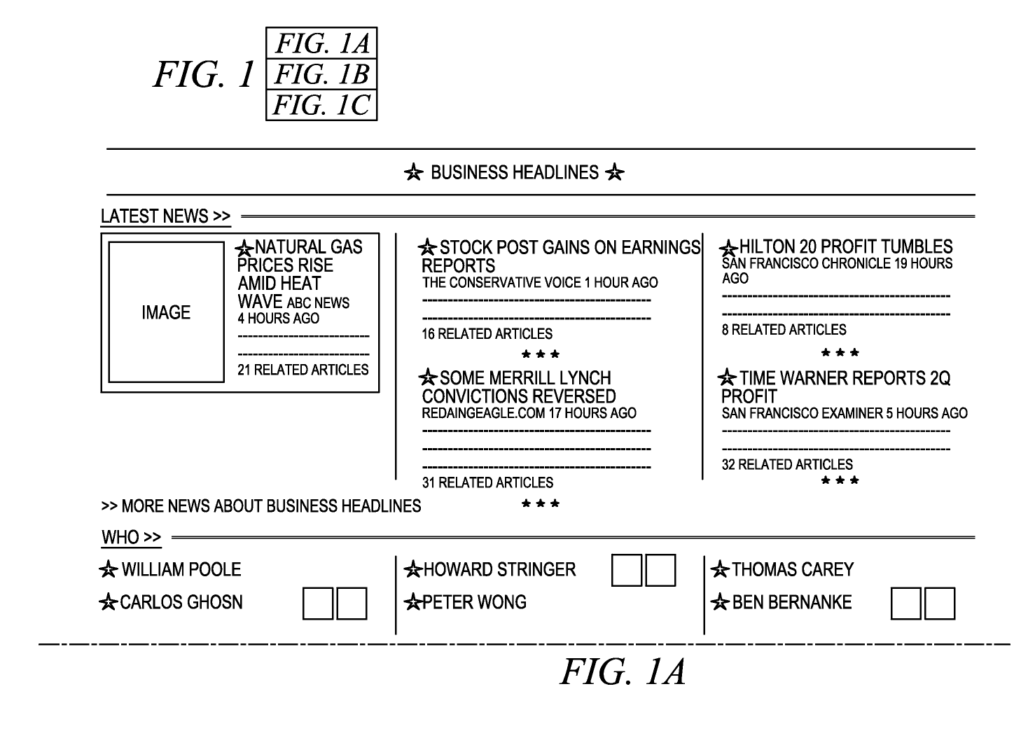

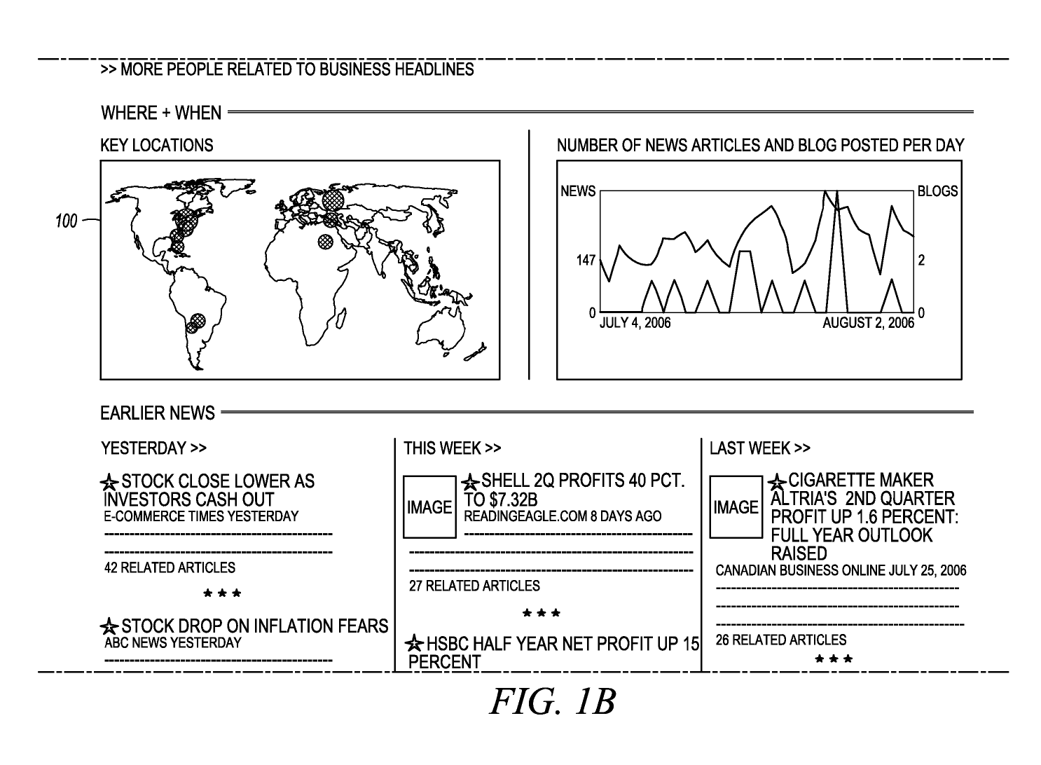

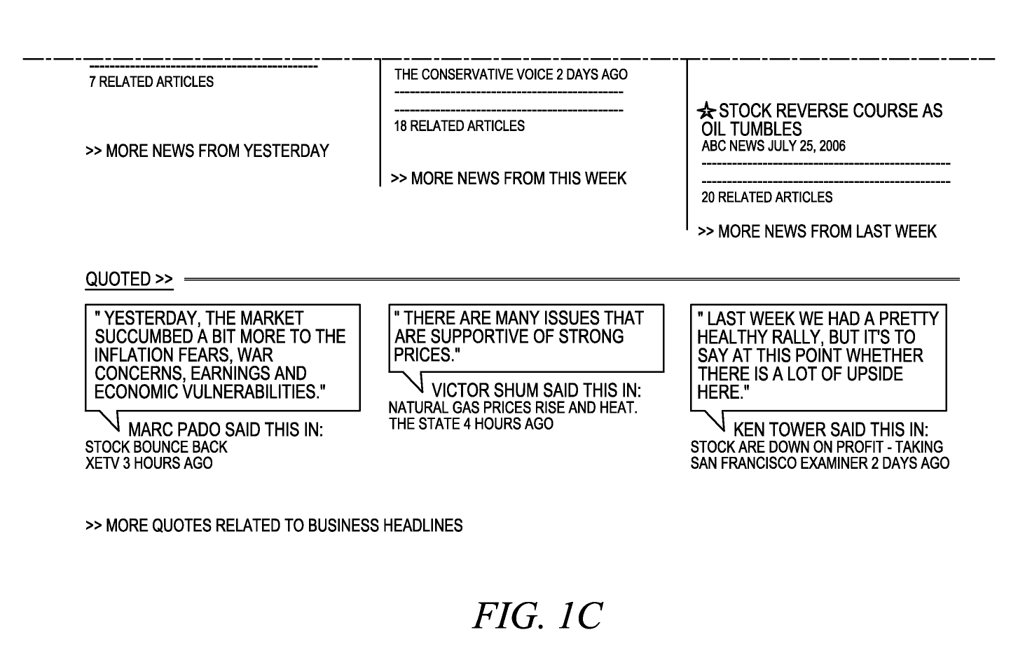

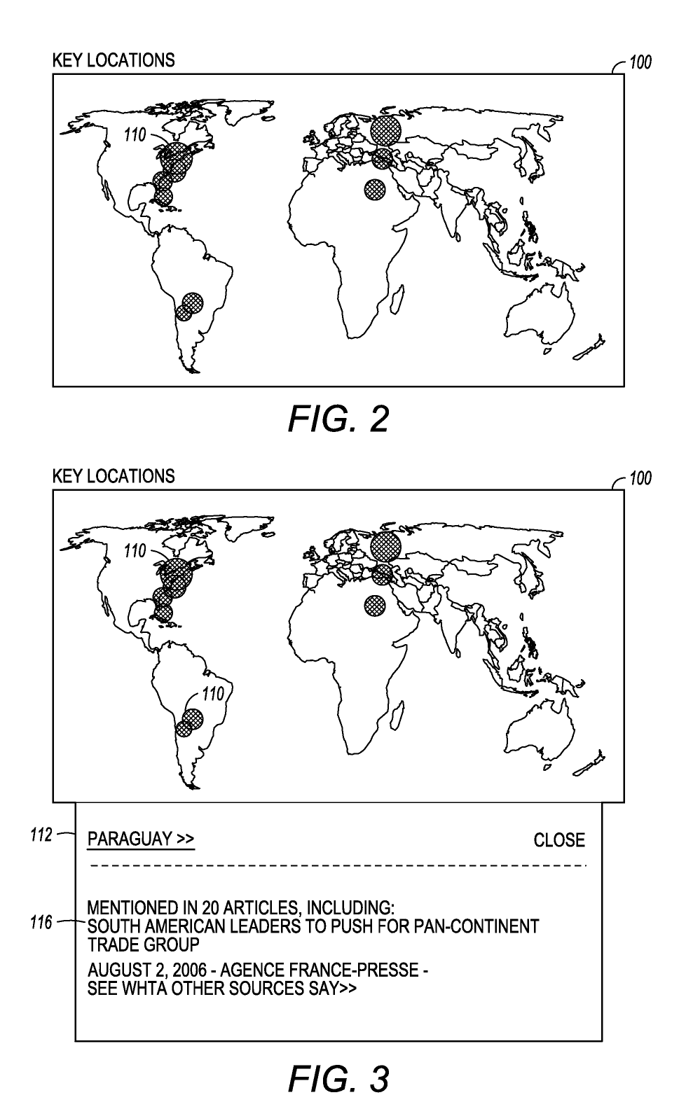

Furthermore, once the entity and article location has been determined and an articles database has been created, with the location information, a news page can be rendered such as shown in FIG. 1. The news page has some of the same elements of prior art news pages, but also includes elements neither suggested nor taught by the prior art. For example, FIG. 1 includes a “Key locations” map (a “map”) 100. FIG. 2 shows an enlarged version of the map 100. The map 100 includes markers, such as dots, overlaid on the map, as shown by the outlined circles 110. The markers 110 indicate where the stories, or at least some of the stories, are taking place, where they are being covered, where they are of interest, and the like.

The markers 110 may comprise attributes such as size, color, and shape, and the attributes may be modified. For example, the markers 110 may be different sizes, and the sizes may vary depending on factors such as the number or frequency of stories available for the particular location. The markers 110 may be different shapes and colors, for example to denote different properties of groups of stories such as where the story is actually taking place, and where the story is being covered or where the story was written.

For example, if a user located in New York is viewing a sports page comprising, among other things, articles about a basketball game between the New York Knicks and the Boston Celtics, the map may have a large red dot over New York and small blue dot over Boston. The map may be displaying oppositely (large red dot over Boston, small blue dot over New York) for a user in Boston. It is understood in the art how to determine where a user viewing a webpage is located.

In another example, many stories may be written about a topic such as riots in Paris, and the stories may be covered by reporters or news organizations in many different parts of the world. In this example, the map may show a large dot over Paris, and smaller dots over places covering the riots, such as New York, London, and Montreal.

FIG. 3 shows an enlarged view of the map after selecting a location on the map. A user may click on any of the markers 110 to display, for example a drop down list, menu, popup, sub-display or equivalent 112 as shown. In FIG. 3, a user clicked on the larger marker 110 in the center of South America, which displays “Paraguay”, which is the location of the stories that are populating the “Business” section of a news page(such as the exemplary news page of FIG. 1).

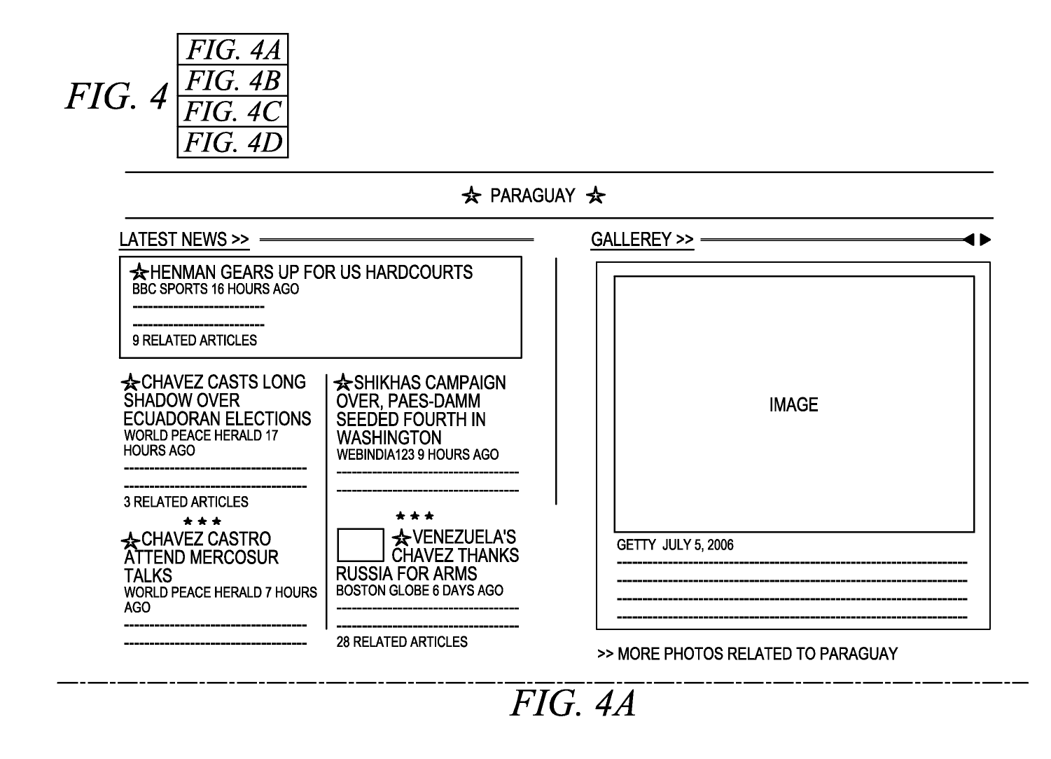

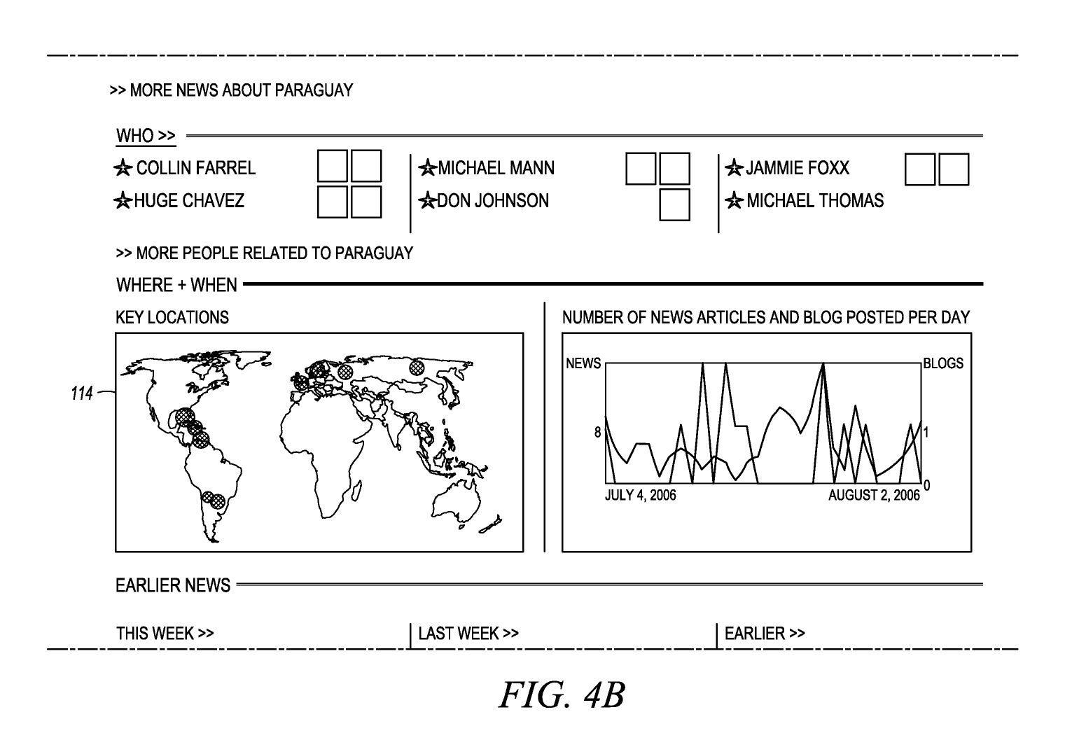

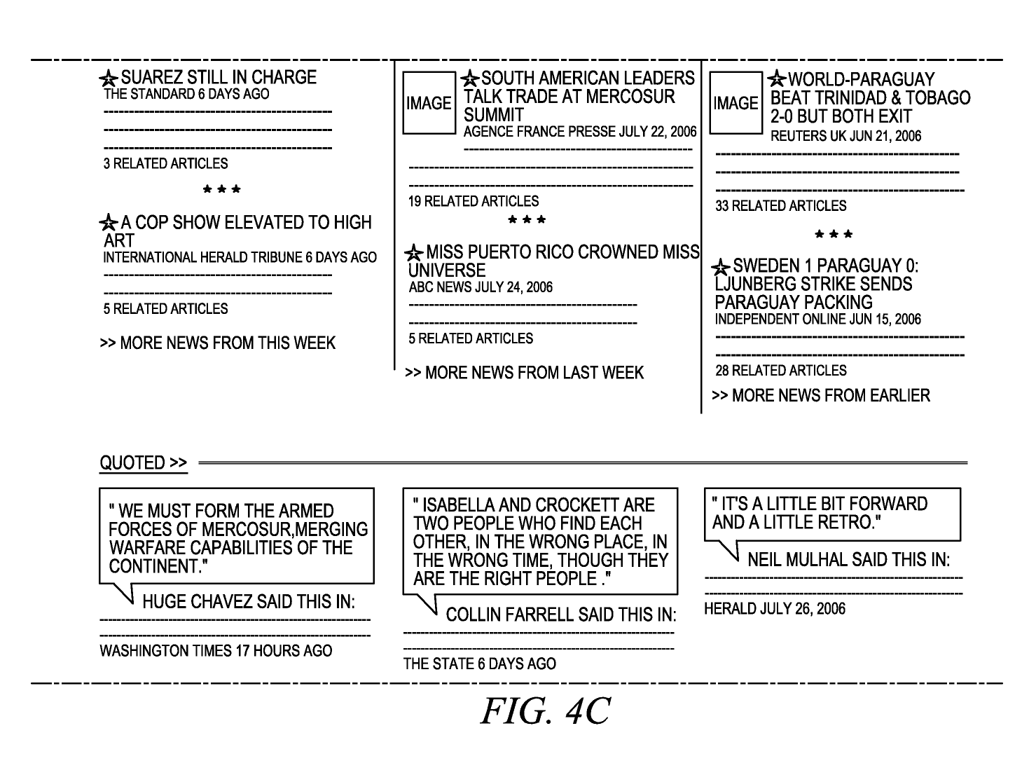

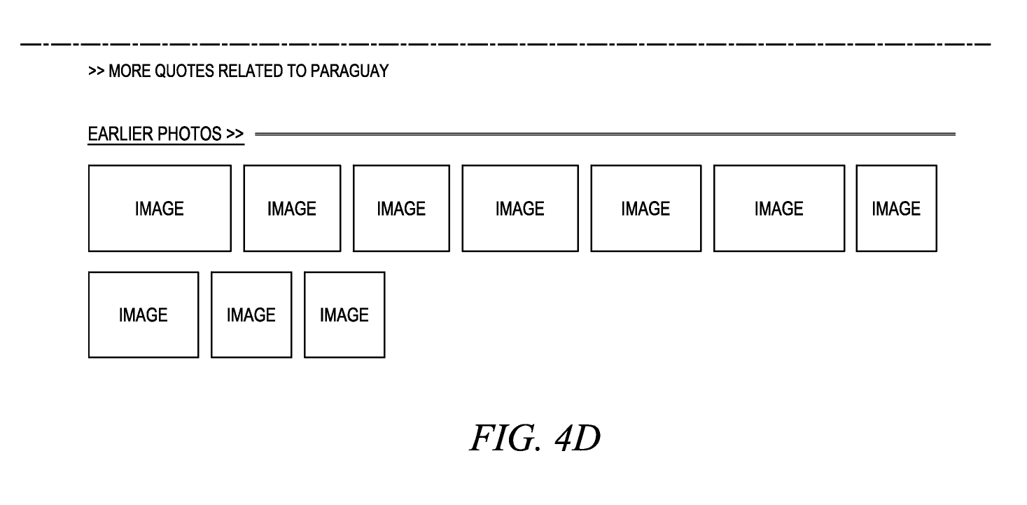

FIG. 4 shows a news page created after selecting a location such as shown in FIG. 3. In the exemplary sub-display 112 of FIG. 3, clicking on “Paraguay>>” instantly publishes the page of FIG. 4, with a single click, of news on Paraguay. That is, a user can browse or navigate to Paraguay news geographically. It is of note that the single click published page of FIG. 4 include all different types of news on Paraguay, not just business news. And, a new map 114 is rendered, with new markers, showing key locations of articles comprising the page. The key locations may be browsed just as described above to display yet more interesting and valuable stories, related in ways not possible to ascertain with the prior art.

Other pages may be created with a single click. For example, turning back to FIG. 3, clicking on “See what other sources say>>” creates a page, with a single click, displaying articles having the same topic as the parent page, in this case “Business” articles, but specific to Paraguay.

As shown in FIG. 3, one sample headline 116 for a related article is shown, however more than one may be shown. In this example, the article title is shown along with the publisher of the article, in this case, “Agence France-Presse”. Clicking on “Agence France-Presse” renders a page showing, for example, top news, photos, and images from “Agence France-Presse”. It should be evident to those skilled in the art that many other pages may be rendered and many other types of maps created.

The foregoing detailed description has discussed only a few of the many forms that this invention can take. It is intended that the foregoing detailed description be understood as an illustration of selected forms that the invention can take and not as a definition of the invention. It is only the following claims, including all equivalents, that are intended to define the scope of this invention.

Appendix A

Preparing the Geographic Database (“database”)

1. Gather raw geographic data from several public sources:
   GEOnet Names System (GNS)
   National Geospatial-Intelligence Agency (NGA)
   U.S. Board on Geographic Names
   Geographic Names Information System (GNIS)
   U.S. Board on Geographic Names
   FIPS 6-4
   FIPS 10-4
   FIPS 55
   National Institute of Standards and Technology (NIST)
   National Atlas of the United States
   United States Department of the Interior
   ISO 3166
   International Organization for Standardization
   Tiger/Line 2005 First Edition
   U.S. Census Bureau
   Vmap0
   National Imagery and Mapping Agency (NIMA)
   Gridded Population of the World, Version 3 (GPWv3)
   Center for International Earth Science Information Network (CIESIN)
   http://sedac.ciesin.columbia.edu/gpw/documentation.jsp
2. The databases are correlated using feature identification codes and merged.

3. Locations are mapped into a hierarchy according to geography type (at the continent level) and political relationship. Each level in the hierarchy currently corresponds to one of the following types:

| | |
|---|---|
| WRLD | Earth |
| CONT1 | Major continent (Americas) |
| CONT2 | Sub-continent (North America) |
| PCL | Political entity (United States) |
| ADM1 | First-order administrative division (New York) |
| ADM2 | Second-order administrative division (Kings County) |
| PPL | Populated place (Williamsburg) |

4. Population data is merged in for PCL, ADM1, ADM2, and PPL locations if available. Where this data is not available, population estimates are calculated based on gridded surface population estimates, such as GPWv3, and a populated place's close proximity to other known places.

5. Once the merge is complete and the hierarchy is calculated, for each location we retain:

| | |
|---|---|
| PlaceId | Unique identifier. |
| Name(s) | Primary and variant names for each place. |
| SortName(s) | Name(s) with diacritical marks stripped. |
| Abbreviations | Shortened versions of name. |
| Parents | Entire hierarchy up to WRLD. |
| Longitude | |
| Latitude | |
| Population | |

Appendix B
Location Resolution Algorithm (“Algorithm”) and Multiple Match Subroutine
A. Location Resolution Algorithm (“algorithm”)
1. The entity extraction process creates a file (“entity file”) containing all named entities extracted for a given article. These entities are grouped into three categories: Person, Organization, Location. The algorithm selects all of the Location entity names (“location entities”) for the given article.
2. For each location entity name (“original name”) in the entity file, the algorithm creates a normalized version of the entity name (“normalized name”) by stripping all diacritical marks from the entity name. This would convert the name “Boca Ratón” to Boca Raton.
3. For each location entity, the algorithm matches the original name against the Name field in the database. If a single match occurs the algorithm chooses that PlaceId. If multiple matches occur, the matches are retained in memory, and the algorithm eventually takes the Multiple Match Subroutine, below. If no matches occur, the algorithm repeats step #3 by matching the normalized name against the SortName field in the database.
4. Once the multiple match subroutine returns, each PlaceId is associated with its entity name and these are written to a file.
   B. Multiple Match Subroutine

This subroutine is used to resolve a PlaceId to an entity in the presence of multiple name matches. For example, the entity name “Springfield” might return several database matches, among these:
PlaceId=1 Springfield, Mass., U.S., Population 111,454
PlaceId=2 Springfield, Va., U.S., Population 30,417

The system must determine which of these to select, so it may attempt to resolve the parents of both locations against other location entities found in the article, and their parents. If the article mentions Virginia, this weighs heavily in favor of resolving “Springfield” to PlaceId:2.
1. The preconditions for entering this sub-branch are:
   A. For each entity there are zero, one, or multiple matches against the database. These matches are retained in local variables.
   B. For at least one of these entities, multiple matches were found.
2. When a name matches multiple database entries, the matching entries are sorted according to their population. Then the hierarchy for each place is retrieved from the database. The list of matches is traversed from most-populous to least-populous.
3. The algorithm then recursively matches each parent against matches for other entities, and their resolved hierarchies. For example, suppose there are two major cities, Boca Raton, Fla. and Boca Raton, Calif. If Florida is also mentioned in the same article, the entity name Boca Raton will resolve to the PlaceId for “Boca Raton, Fla.”.
   This recursive match works its way up the list of parents until it finds a match. For example in the case of “PlaceId=3, San Juan, Puerto Rico, U.S.” and “PlaceId=4, San Juan, Argentina”, an article also mentioning “Argentina” would resolve the entity name “San Juan” to PlaceId:4.
4. If multiple matches exist for an entity name and the recursive parent match fails to return a PlaceId, the PlaceId with the largest population is selected.
5. Finally, the resolved PlaceId is returned to the main routine of the algorithm.

What is claimed is:

1. A method for determining and displaying the geographic location of a plurality of articles comprising:
determining at least one geographic location of each of the plurality articles;
creating a map; and
displaying a plurality of clickable markers on the map corresponding to the at least one geographic location of each of the plurality of articles.

2. The method of claim 1 wherein said determining at least one geographic location of each of the plurality articles comprises, for each article of the plurality of articles:
extracting entities of the article;
determining which extracted entities are places entities;
determining a geographic location of each of the places entities; and
attributing the geographic location of each of the places entities with the article.

3. The method of claim 2 further comprising computing a relevancy of the geographic location of each of the places entities.

4. The method of claim 1 wherein said displaying further comprises modifying attributes of the clickable markers.

5. The method of claim 4 wherein said modifying comprises varying a size of the clickable markers according to a frequency of stories.

6. The method of claim 4 wherein said modifying comprises modifying attributes according to a location of a viewer viewing the map.

7. The method of claim 1 further comprising:
receiving a click on a clickable marker of the plurality of clickable markers; and
instantly publishing a web page of articles having a geographic location of the clickable marker.

8. The method of claim 7 wherein said instantly publishing comprises:
determining at least one geographic location of the articles of the instantly published web page;
creating a new map; and
displaying on the instantly published web page a plurality of clickable markers on the new map corresponding to the at least one geographic location of each of the plurality of articles;

9. The method of claim 1 further comprising:
receiving a click on a clickable marker of the plurality of clickable markers; and
displaying articles having the location of the clickable marker.

10. The method of claim 9 where said displaying articles comprising displaying headlines of the articles.

11. A method for determining and displaying the geographic location of a plurality of articles comprising:
determining at least one geographic location of each of the plurality articles, wherein said determining comprises,
extracting entities of the article;
determining which extracted entities are places entities;
determining a geographic location of each of the places entities;
attributing the geographic location of each of the places entities with the article;
creating a map, wherein said map is a geographic map; and
displaying a plurality of clickable markers on the map corresponding to the at least one geographic location of each of the plurality of articles, wherein said displaying comprises modifying attributes of the clickable markers.

12. The method of claim 11 further comprising:
receiving a click on a clickable marker of the plurality of clickable markers; and
displaying articles having the location of the clickable marker.

13. A computer readable medium having stored thereon instructions for determining and displaying the geographic location of a plurality of articles which, when executed by a processor causes the processor to perform the steps of:
determining at least one geographic location of each of the plurality articles;
creating a map; and
displaying a plurality of clickable markers on the map corresponding to the at least one geographic location of each of the plurality of articles;

14. The computer readable medium of claim 13 further having stored thereon instructions for determining and displaying the geographic location of a plurality of articles which, when executed by a processor causes the processor to perform the steps of:
extracting entities of the article;
determining which extracted entities are places entities;
determining a geographic location of each of the places entities; and
attributing the geographic location of each of the places entities with the article.

15. The computer readable medium of claim 13 further having stored thereon instructions for determining and displaying the geographic location of a plurality of articles which, when executed by a processor causes the processor to perform the steps of:
receiving a click on a clickable marker of the plurality of clickable markers; and
displaying articles having the location of the clickable marker.
